(19) United States
(12) Patent Application Publication
(10) Pub. No.: US 2025/0206955 A1
(43) Pub. Date: Jun. 26, 2025

(54) RECOVERED CARBON BLACK OBTAINED BY SOLVOLYSING TYRES

(71) Applicant: IFP ENERGIES NOUVELLES, Rueil-Malmaison (FR)

(72) Inventors: Saloua SAHAL-EL AHRACHE, Rueil-Malmaison Cedex (FR); Severine HUMBERT, Rueil-Malmaison Cedex (FR); Alexandra CHAUMONNOT, Rueil-Malmaison Cedex (FR); Khaled BELHADDAD, Rueil-Malmaison Cedex (FR)

(73) Assignee: IFP ENERGIES NOUVELLES, Rueil-Malmaison (FR)

(21) Appl. No.: 18/852,028

(22) PCT Filed: Mar. 14, 2023
(86) PCT No.: PCT/EP2023/056441

§ 371 Date: Sep. 27, 2024

(30) Foreign Application Priority Data
Mar. 30, 2022 (FR) FR2202850

(51) Int. Cl. C09C 1/48; C09C 1/56; C10G 1/06

(52) U.S. Cl. CPC C09C 1/482; C09C 1/56; C10G 1/065; C01P 2002/80; C01P 2006/12; C01P 2006/80; C10G 2300/1003

(57) ABSTRACT

Recovered carbon black (rCB) comprising carbon black, inorganic ash and carbon-based residues resulting from the decomposition of pneumatic rubbers and/or elastomer residues, characterized in that said content of carbon-based residues, determined with respect to the percentage of area of the C₁ peak measured by X-ray photoelectron spectroscopy, is less than or equal to 1% of said area of the C₁ peak, said percentage of area of the C₁ peak being calculated with respect to the total area of the C₀ to C₅ peaks.

### FIELD OF THE INVENTION

The present invention relates to the field of carbon-based materials of carbon black type, in particular to “recovered” carbon blacks (or rCBs), obtained by thermochemical transformation of tyres at the end of life. It also relates to a process for the preparation of these rCBs via a process for the solvolysis of waste tyres with recycle of a hydrocarbon cut comprising aromatic compounds.

### STATE OF THE ART

Tyres are mainly constituted of rubbers, for their elastic property (mixture of elastomers of the type of crosslinked synthetic and natural rubbers, with the addition of adjuvants of the type of silica, resin, sulfur, zinc oxide, carbon black, and the like), and of textile and metal fibres, for their reinforcing property. Carbon blacks (or CBs) are in particular used in the formulations of rubbers for improving the resistance of the latter (in terms of robustness and of lifetime), for limiting the deformation of the tyres in use and for facilitating heat transfers between the tyres and the ground during running. They are generally obtained by incomplete combustion of vegetable oils or hydrocarbons and more than 35 grades of them exist, sold and used as filler (essentially for the formulation of pneumatic tyres). Their quality differs according to their intrinsic properties.

The majority of carbon blacks are characterized by high contents of elemental carbon (>90% by weight with respect to the total weight of the carbon black) and can contain other chemical elements, such as hydrogen, oxygen, nitrogen and sulfur, which are chemically bonded to the carbon. They are generally provided in the form of black powders constituted of elementary graphite particles (more or less highly crystalline) which are virtually spherical (10 to 500 nm), forming aggregates (100 to 1000 nm) which can themselves gather together in the form of agglomerates (1 to 100 μm), it then being possible for the whole to be transformed into granules (0.1 to 1 mm). The size of the elementary particles and the structure of the objects (morphology, size, density/aeration of the aggregates/agglomerates) will greatly impact the ability of the carbon blacks to disperse in an elastomer matrix and thus, in fine, the reinforcing properties of these blacks within a tyre. The “specific surface” (or SBET) parameter, determined by nitrogen physisorption, is characteristic of the size of the elementary particles and gives information about the surface of the carbon black potentially in interaction with the elastomer matrix. The structure of a carbon black is characterized, for its part, by the ability of the latter to develop a porosity capable of being filled by a liquid paraffin and thus, eventually, by an elastomer matrix. A structural index, equivalent to an oil adsorption number, is then determined, the associated analytical method being the OAN (Oil Adsorption Number) method. An abbreviation of the NXYZ type, where X is a figure characteristic of the SBET of the carbon black and Y and Z are figures arbitrarily designated as a function of the structure observed, is then associated with each carbon black. On balance, there exists a relationship SBET/OAN structural index which makes it possible to classify the various carbon blacks as a function of their grade and of their reinforcing or non-reinforcing nature. For example, the carbon blacks N110, N120 and N234, which are very good reinforcing adjuvants, are characterized by a high specific surface and a high structural index. Depending on their intrinsic properties, the carbon blacks will be used to formulate different rubbers, themselves employed in the various constituent elements of a tyre.

During their recycling, tyres are generally initially ground in order to obtain either ground tyre material still containing a portion of the textile and metal fibres (typically pieces of 1 to 10 cm) or granules (with dimensions generally of less than 6 mm) devoid of any fibres. It is then possible to convert them into gaseous, liquid or solid fractions via thermal decomposition conversion processes. The solid fraction obtained is predominantly constituted of various grades of carbon blacks as a mixture, with the addition of inorganic ash (predominantly of the type of silica and Zn-based compounds). Furthermore, the thermal decomposition of the “elastomers” fraction generates carbon-based compounds of varied nature (various optionally recondensed decomposition products) capable of being deposited at the surface of the carbon blacks. Likewise, depending on the operating conditions of said processes, polymer chains of non-decomposed elastomers can be adsorbed at the surface. For a given conversion process applied to a specific “waste tyres” feedstock, the rCB then represents all of the solid fraction constituted of the initial carbon blacks as a mixture and modified at the surface by various carbon-based deposits (decomposition products and/or elastomer residues), and also inorganic ash. The intrinsic properties of an rCB are thus a function of the elements which constitute it. In particular, the chemical composition of the rCBs, the degree of agglomeration of the aggregates and their structure, and consequently the redispersion properties of the rCBs in an elastomer matrix, can be drastically modified, with respect to those of the starting carbon blacks, as a function of the composition of the tyres at the end of life which are treated (choice of the feedstock) and of the recycling process envisaged.

Among the processes for conversion by thermal decomposition which are possible for the treatment of the tyres at the end of life, pyrolysis processes are very frequently encountered (J. Yu et al., Frontiers of Environmental Science & Engineering, 2020, 14, 2, 7982; S. Q. Li et al., Ind. Eng. Chem. Res., 2004, 43, 5133; EP 2 661 475). They usually consist in exposing the tyres to temperatures of between 350° C. and 800° C. in the absence of oxygen, or in the presence of a very small amount of oxygen or of air designed to contribute, by very partial combustion, the energy necessary for the pyrolysis process. The latter is operated at the atmospheric pressure of the gas(es) under consideration or sometimes under vacuum, so as to minimize the post-degradation side reactions of the pneumatic tyres which frequently result in the formation of residual carbon-based deposits at the surface of the final rCB which have already been mentioned. Multiple technologies are employed, such as the use of fixed bed, moving bed or rotary kiln reactors, and the like. The yields of these rCB processes are highly variable (between 25% and 60% approximately) and it is the same for the intrinsic properties of the latter (for example, the content of residual inorganic ash can vary from 8% to 41% by weight). On the other hand, the rCBs obtained post-pyrolysis (also frequently referred to as “pCBs”) are all characterized by the not insignificant presence of carbon-based deposits at the surface of the starting carbon blacks. The latter are in particular characterized by virtue of the X-ray Photoelectron Spectroscopy (XPS) surface analysis technique, also referred to as ESCA (Electron Spectroscopy for Chemical Analysis). First, this surface analysis makes it possible to define the elementary chemical composition of a material and to thus determine the contents of C, O, N, S, Si, Al, Zn, and the like, present. Subsequently, the precise analysis of the spectrum associated with the element carbon (C1s spectrum) gives information about the chemical environment of the constituent carbon atoms of the rCB (thesis Ludovic Moulin: Valorisation du noir de carbone récupéré, relation procédé-produit [Upgrading of Recovered Carbon Black, Process-Product Relationship]. Process engineering. Ecole des Mines d'Albi-Carmaux, 2018). It makes it possible in particular to distinguish the carbon associated with the starting carbon blacks (C₀ peak corresponding to a bond energy of approximately 284.2/284.8 eV, characteristic of C—C/C—H bonds of a graphite structure) from that relating to the carbon-based compounds liable to be deposited at the surface (C₁ peak corresponding to a bond energy of approximately 284.8/285.6 eV, characteristic of C—C/C—H bonds of aliphatic structures or of small aromatic compounds, associated in this instance with the carbon-based deposits formed during the pyrolysis processes). Thus, the pCBs exhibit contents of carbon-based deposits, evaluated as % of area by XPS, of between 5% and 40% (calculation based on the total area of the C₀ and C₁ peaks described above and of the C₂, C₃, C₄ and C₅ peaks respectively assigned to the C—O, C═O and COOH bonds and to the π-π* transitions). These carbon-based deposits are in large part responsible for the agglomeration phenomena binding the diverse structures of the rCBs at different scales; the solid exiting from the reactor is often present in the form of blocks of several millimetres/centimetres which it is then necessary to finely ground in order to reuse it (in particular as adjuvant for the formulation of new rubbers), which requires a major energy expenditure. It should be specified that these carbon-based deposits appear strongly bonded to the surface of the starting carbon blacks since even heat post-treatments at higher temperatures than the pyrolysis process in itself are not sufficient to remove them (change from 40% to 20% of area of the C₁ peak for a post-pyrolysis heat treatment at 600° C.: H. Darmstadt et al., Carbon, 1995, 33, 10, 1449).

In order to limit the formation of carbon-based deposits on the rCB, it is possible to lower the partial pressure of hydrocarbons by injecting steam during the cracking reactions (steam thermolysis processes). Unfortunately, the high temperature conditions generally applied (often above 500° C.) result even so in the formation of carbon-based deposits, although in limited proportions (from 5% to 6% of area of the C₁ peak). Furthermore, these gas-solid processes exhibit other disadvantages. This is because they generally bring about high productions of non-condensable gases (in atmospheric conditions) often of between 10% and 25% by weight with respect to the feedstock of waste tyres entering the reactor, which is done to the detriment of the amount of liquid products potentially recoverable and readily upgradable. This is because these liquid fractions can be employed to produce new hydrocarbon cuts (naphtha, petrol, kerosene, gas oil, vacuum distillate, residues) used in a refinery to produce fuels or in petrochemistry to produce bases subsequently used to prepare plastics.

Another alternative route advantageous for limiting the presence of these carbon-based deposits on an rCB consists in bringing the tyre feedstocks into contact with a liquid under suitable operating conditions (in particular of temperature) and in dissolving and converting the tyres in a homogeneous liquid phase in which the tyre feedstock will be stirred and will gradually disappear. Patents U.S. Pat. Nos. 3,978,199 and 3,704,108 disclose processes for the conversion of waste tyres comprising a stage of dissolution of the solid feedstock based on waste tyres in the presence of a solvent corresponding to a recycle of the heavy liquid fraction of the filtrate obtained after distillation, comprising compounds rich in aromatics (preferentially monoaromatics). Unfortunately, the conditions for implementation of such processes, and more particularly the choice of a heavy liquid fraction as solvent, are not favourable to the non-formation of the carbon-based deposits contained in the final rCB.

The Applicant Company has developed a novel process for the conversion of waste tyres which makes it possible to obtain a “recovered” carbon black (rCB) comprising a very low content of carbon-based residues (decomposition products of pneumatic rubbers and/or elastomer residues), limiting in this also the phenomena of agglomeration of the various structures of the rCB generally encountered during the processes employed in the literature. Said process consists in recycling a feedstock of waste tyres at a temperature of less than or equal to 400° C. and at a pressure of less than 1.5 MPa, via the operation in which said feedstock is brought into contact with a solvent constituted of at least a hydrocarbon cut comprising a rich content of aromatic compounds, a low content of C40+ compounds (vacuum residues) and a moderate content of C5-C10 hydrocarbon compounds (petrol), it being possible for said solvent to result from the process itself (recycle). Said process is also characterized by a ratio by weight of the liquid solvent to the specific feedstock, that is to say by a ratio by weight of greater than 3 weight/weight. The operating conditions, the composition of the hydrocarbon cut and the solvent/solid feedstock ratio by weight as defined make it possible to maximize the production of rCB via a better dissolution/decomposition of the solid feedstock while limiting the presence of carbon-based residues in the final rCB. Furthermore, such a process limits the formation of gases to contents of between 1% and 7% by weight of the feedstock to be treated.

### Subject-Matters of the Invention

The present invention relates to a recovered carbon black (rCB) comprising carbon black, inorganic ash and carbon-based residues resulting from the decomposition of pneumatic rubbers and/or elastomer residues, characterized in that said content of carbon-based residues, determined with respect to the percentage of area of the C₁ peak measured by X-ray photoelectron spectroscopy, is less than or equal to 1% of said area of the C₁ peak, said percentage of area of the C₁ peak being calculated with respect to the total area of the C₀ to C₅ peaks.

According to one or more embodiments, said recovered carbon black comprises between 50% and 98% by weight of element carbon with respect to the total weight of said recovered carbon black.

According to one or more embodiments, said recovered carbon black comprises between 0.5% and 4% by weight of element oxygen with respect to the total weight of said recovered carbon black.

According to one or more embodiments, said recovered carbon black comprises between 0.2% and 3% by weight of element hydrogen with respect to the total weight of said recovered carbon black.

According to one or more embodiments, said recovered carbon black comprises between 0.05% and 1% by weight of element nitrogen with respect to the total weight of said recovered carbon black.

According to one or more embodiments, said recovered carbon black comprises between 0.5% and 6% by weight of element sulfur with respect to the total weight of said recovered carbon black.

According to one or more embodiments, said recovered carbon black comprises a content of extracted volatile organic compounds of between 0.2% and 20% by weight with respect to the total weight of said recovered carbon black.

According to one or more embodiments, said recovered carbon black comprises a content of inorganic ash of between 4% and 50% by weight with respect to the total weight of said recovered carbon black.

According to one or more embodiments, said recovered carbon black comprises a specific surface of between 30 and 150 m²/g.

According to one or more embodiments, said recovered carbon black comprises a structural index, determined by the OAN analytical method in accordance with Standard ASTM D2414, of between 55 and 110.10-5 m³/kg.

According to one or more embodiments, said content of carbon-based residues, calculated with respect to the % of area of the C₁ peak, measured by photoelectron spectroscopy, is between 0.001% and 0.05% of area of the C₁ peak, said percentage of area of the C₁ peak being calculated with respect to the total area of the C₀ to C₅ peaks.

Another subject-matter relates to a process for the conversion of waste tyres in order to obtain recovered carbon black (rCB) according to the invention, said process comprising at least the following stages:
a) a solid feedstock based on waste tyres is sent into a reaction zone in the presence of a liquid solvent comprising aromatic compounds in order to at least partially dissolve said solid feedstock and to thermally decompose said at least partially dissolved solid feedstock at a temperature of less than 400° C. and at a pressure of less than 1.5 MPa in order to obtain a gaseous effluent and a first liquid effluent comprising the carbon black, the ratio by weight of the liquid solvent to the solid feedstock being greater than 3 weight/weight;
b) the first liquid effluent obtained in stage a) is sent into a zone for filtration and washing in the presence of a washing solvent in order to obtain a cake of filtered and washed carbon black and a second liquid effluent, said stage b) being carried out at a temperature of between 55° C. and 95° C.;
c) said gaseous effluent obtained on conclusion of stage a) is sent, at least in part, and the second liquid effluent obtained on conclusion of stage b) is sent, at least in part, to a fractionation zone in order to obtain at least a hydrocarbon cut comprising a content of aromatic compounds of greater than 30% by weight with respect to the total weight of said hydrocarbon cut, and additionally comprising:
a content of C5-C10 hydrocarbon compounds of less than 20% by weight with respect to the total weight of the hydrocarbon cut; and
a content of C40+ hydrocarbon compounds of less than 5% by weight with respect to the total weight of said hydrocarbon cut;
d) said hydrocarbon cut obtained on conclusion of stage c) is sent, at least in part, into the reaction zone as liquid solvent of stage a);
e) the cake of filtered and washed carbon black obtained on conclusion of stage b) is dried at a temperature of between 5° and 200° C. in order to recover the carbon black.

According to one or more embodiments, stage a) comprises the following sub-stages:
a1) said solid feedstock and said liquid solvent are sent into a first stirred reactor in order to at least partially dissolve said solid feedstock;
a2) said at least partially dissolved solid feedstock obtained on conclusion of stage a1) is sent into a second stirred reactor in order to thermally decompose said solid feedstock at a temperature of less than or equal to 400° C. and to obtain a liquid effluent containing carbon black particles in suspension.

According to one or more embodiments, the content of aromatic compounds of the hydrocarbon cut is greater than 40% by weight with respect to the total weight of said cut.

According to one or more embodiments, the content of C40+ hydrocarbon compounds in the hydrocarbon cut is less than 3% by weight with respect to the total weight of said cut.

Another subject-matter according to the invention relates to a recovered carbon black (rCB) obtained by a process for the conversion of waste tyres comprising at least the following stages:
a) a solid feedstock based on waste tyres is sent into a reaction zone in the presence of a liquid solvent comprising aromatic compounds in order to at least partially dissolve said solid feedstock and to thermally decompose said at least partially dissolved solid feedstock at a temperature of less than 400° C. and at a pressure of less than 1.5 MPa in order to obtain a gaseous effluent and a first liquid effluent comprising the carbon black, the ratio by weight of the liquid solvent to the solid feedstock being greater than 3 weight/weight;
b) the first liquid effluent obtained in stage a) is sent into a zone for filtration and washing in the presence of a washing solvent in order to obtain a cake of filtered and washed carbon black and a second liquid effluent, said stage b) being carried out at a temperature of between 55° C. and 95° C.;
c) said gaseous effluent obtained on conclusion of stage a) is sent, at least in part, and the second liquid effluent obtained on conclusion of stage b) is sent, at least in part, to a fractionation zone in order to obtain at least a hydrocarbon cut comprising a content of aromatic compounds of greater than 30% by weight with respect to the total weight of said hydrocarbon cut, and additionally comprising:
a content of C5-C10 hydrocarbon compounds of less than 20% by weight with respect to the total weight of the hydrocarbon cut; and
a content of C40+ hydrocarbon compounds of less than 5% by weight with respect to the total weight of said hydrocarbon cut;
d) said hydrocarbon cut obtained on conclusion of stage c) is sent, at least in part, into the reaction zone as liquid solvent of stage a);
e) the cake of filtered and washed carbon black obtained on conclusion of stage b) is dried at a temperature of between 5° and 200° C. in order to recover the carbon black.

### LIST OF THE FIGURES

FIG. 1 is a diagrammatic representation of an embodiment for obtaining a carbon black according to the invention.

FIG. 2 is a diagrammatic representation of the process represented in FIG. 1 in which the reaction zone and the filtration and washing zone of the process are shown in more detail.

### DETAILED DESCRIPTION OF THE INVENTION

### 1. Definitions

Cn hydrocarbon cut is understood to mean a cut comprising hydrocarbons having n carbon atoms.

Cn+ cut is understood to mean a cut comprising hydrocarbons having at least n carbon atoms.

The BET specific surface is measured by nitrogen physisorption. The BET specific surface is measured by nitrogen physisorption according to Standard ASTM D3663-03 as described in Rouquerol F., Rouquerol J. and Singh K., “Adsorption by Powders & Porous Solids: Principles, Methodology and Applications”, Academic Press, 1999.

The CHNS—O elemental analyse, carried out according to Standard ASTM D5291, is a method well known to a person skilled in the art, that makes possible the rapid determination of the carbon (C), hydrogen (H), oxygen (O), nitrogen (N) and sulfur(S) contents of organic matter and of other types of materials, on the basis of the complete combustion of the withdrawn analytical sample at 1000° C. under oxygen.

The content of carbon-based residues is evaluated by the X-ray Photoelectron Spectroscopy (XPS) surface analysis technique well known to a person skilled in the art, and in particular by the precise analysis of the spectrum associated with the element carbon (C1s spectrum), which gives information about the chemical environment of the constituent C atoms of the rCB. Specifically, the content of said carbon-based residues is determined by the % of area of the C₁ peak corresponding to a bond energy of approximately 284.8/285.6 eV, characteristic of C—C/C—H bonds of aliphatic structures or of small aromatic compounds which are associated with said residues, which is calculated with respect to the total area of the C₀ to C₅ peaks (C₀ being the peak associated with the C—C/C—H bonds of a graphite structure and C₂, C₃, C₄ and C₅ the peaks respectively assigned to the C—O, C—O, COOH bonds and to the π-π* transitions). The method of measurement of the content of carbon-based residues is described in detail in the publication by Darmstadt H., Roy C. and Kaliaguine S., “Characterization of pyrolytic carbon blacks from commercial tire pyrolysis plants”, Carbon, Volume 33, No. 10 (1995), pp. 1449-1455, but also in the publication by Bendida Sahouli, Silvia Blacher, François Brouers, Hans Darmstadt, Christian Roy and Serge Kaliaguine: “Surface morphology and chemistry of commercial carbon black and carbon black from vacuum pyrolysis of used tyres”, Fuel, Vol. 75, No. 10 (1996), pp. 1244-1250, or also in the thesis of Ludovic Moulin: Valorisation du noir de carbone récupéré, relation procédé-produit [Upgrading of Recovered Carbon Black, Process-Product Relationship]. Process engineering. Ecole des Mines d'Albi-Carmaux, 2018.

Thermogravimetric analysis is a technique widely used and well known to a person skilled in the art, just as well for measuring the moisture content, the content of volatiles and the ash content of rCBs. The protocol used is derived from Standard ISO 9924-2, used mainly for vulcanisates and non-vulcanized mixtures. A first rise in temperature, from 25° C. to 600° C., under nitrogen makes it possible to measure the water content (loss of weight in % between 25° C. and 150° C.) and the content of volatiles and/or pyrolysable phase (loss of weight between 150° C. and 600° C.). Subsequent to this first stage, the sample is subsequently cooled under nitrogen to 400° C. A second rise in temperature, under air, between 400° C. and 950° C. makes it possible to carry out the combustion of the carbon and to measure the amount of carbon (rCB and possible carbon-based residues). The final weight measured at the end of the protocol makes it possible to determine the content of inorganics. This method of analysis is described in detail in the publication by Norris, C., Hale, Mike and Bennett, M., “Pyrolytic carbon: Factors controlling in-rubber performance”, Plastics, Rubber and Composites, Vol. 43 (2014), pp. 245-256.

### 2. Recovered Carbon Black (rCB)

The recovered carbon black (rCB) according to the invention comprises, preferably is constituted of, carbon black (CB), inorganic ash and carbon-based residues resulting from the decomposition of pneumatic rubbers and/or elastomer residues which are associated with said pneumatic rubbers, characterized in that said content of carbon-based residues, determined with respect to the percentage of area of the C₁ peak measured by X-ray photoelectron spectroscopy, is less than or equal to 1% of said area of the C₁ peak, preferably between 0.001% and 0.08% of area, more preferentially between 0.001% and 0.07% of area and more preferentially still between 0.001% and 0.05% of area, said percentage of area of the C₁ peak being calculated with respect to the total area of the C₀ to C₅ peaks.

More particularly, the rCB comprises between 50% and 98% by weight of element carbon with respect to the total weight of said rCB, preferably between 60% and 90% by weight and more preferably still between 65% and 85% by weight. The carbon content was evaluated by CHNS—O elemental analysis.

More particularly, the rCB comprises between 0.2% and 4% by weight of element oxygen with respect to the total weight of the rCB, preferably between 0.4% and 3% by weight and more preferably still between 0.8% and 2.7% by weight.

More particularly, the rCB comprises between 0.2% and 3% by weight of element hydrogen with respect to the total weight of the rCB, preferably between 0.4% and 2.5% by weight and more preferably still between 0.5% and 1.5% by weight.

More particularly, the rCB comprises between 0.05% and 1% by weight of element nitrogen with respect to the total weight of the rCB, preferably between 0.1% and 0.7% by weight and more preferably still between 0.15% and 0.4% by weight.

More particularly, the rCB comprises between 0.5% and 6% by weight of element sulfur with respect to the total weight of the rCB, preferably between 1.5% and 5% by weight and more preferably still between 2% and 3.5% by weight.

The carbon (C), hydrogen (H), oxygen (O), nitrogen (N) and sulfur(S) contents were measured by CHNS—O elemental analysis.

Under the effect of a specific heat treatment (up to 600° C. under nitrogen, for example, by thermogravimetric analysis, “TGA”), these elements can be released from the rCB in the form of vaporized water or of volatile organic compounds (VOCs). The amount of VOCs extracted is also characteristic of the rCB according to the invention. Advantageously, the content of VOCs extracted is between 0.2% and 20% by weight with respect to the total weight of the rCB, preferably between 0.5% and 7% by weight and more preferably still between 0.5% and 4% by weight.

The rCB according to the invention also comprises inorganic ash. The inorganic ash is constituted of at least the atomic element Si, predominantly present in its oxidized form SiO₂ (silica), and of at least the element zinc, predominantly present in its oxidized form ZnO (zinc oxide) and/or its sulfide form ZnS (zinc sulfide), preferably in its sulfide form ZnS. The application of a specific heat treatment (of at least 950° C. under air, by TGA analysis) makes it possible to quantify the content of inorganic ash present in the rCB according to the invention. Thus, the content of inorganic ash is advantageously between 4% and 50% by weight with respect to the total weight of the rCB, preferably between 8% and 40% by weight and more preferably still between 10% and 30% by weight.

The rCB according to the invention can also contain other heteroelements at elemental contents of less than 1% by weight with respect to the total weight of the rCB, preferably of less than 0.5% by weight and more preferably still of less than 0.2% by weight. Said heteroelements can, for example and nonlimitingly, be the elements Al, Ca, Mg, Cl, Fe, K, Br, Co, Ti and P. The measurement of the content of these elements can be carried out by X-ray fluorescence.

Advantageously, the rCB according to the invention comprises a specific surface, determined by nitrogen physisorption, of between 30 and 150 m²/g, preferably between 50 and 90 m²/g and more preferably still between 50 and 75 m²/g.

Advantageously, the structural index, determined by the OAN analytical method in accordance with Standard ASTM D2414, is between 55 and 110.10-5 m³/kg, preferably between 55 and 90.10-5 m³/kg.

The carbon black (CB) contained in the recovered carbon black (rCB) can comprise several grades of commercial carbon blacks, taken alone or as a mixture.

The recovered carbon black (rCB) is capable of being obtained by a process for the conversion of waste tyres comprising at least the following stages:
a) a solid feedstock based on waste tyres is sent into a reaction zone in the presence of a liquid solvent comprising aromatic compounds in order to at least partially dissolve said solid feedstock and to thermally decompose said at least partially dissolved solid feedstock at a temperature of less than 400° C. and at a pressure of less than 1.5 MPa in order to obtain a gaseous effluent and a first liquid effluent comprising the carbon black, the ratio by weight of the liquid solvent to the solid feedstock being greater than 3 weight/weight;
b) the first liquid effluent obtained in stage a) is sent into a zone for filtration and washing in the presence of a washing solvent in order to obtain a cake of filtered and washed carbon black and a second liquid effluent, said stage b) being carried out at a temperature of between 55° C. and 95° C.;
c) said gaseous effluent obtained on conclusion of stage a) is sent, at least in part, and the second liquid effluent obtained on conclusion of stage b) is sent, at least in part, to a fractionation zone in order to obtain at least a hydrocarbon cut comprising a content of aromatic compounds of greater than 30% by weight with respect to the total weight of said hydrocarbon cut, and additionally comprising:
   a content of C5-C10 hydrocarbon compounds of less than 20% by weight with respect to the total weight of the hydrocarbon cut; and
   a content of C40+ hydrocarbon compounds of less than 5% by weight with respect to the total weight of said hydrocarbon cut;
d) said hydrocarbon cut obtained on conclusion of stage c) is sent, at least inpart, into the reaction zone as liquid solvent of stage a);
e) the cake of filtered and washed carbon black obtained on conclusion of stage b) is dried at a temperature of between 5° and 200° C. in order to recover the carbon black.

Unless otherwise indicated, all the variants and embodiments described above can be combined with one another.

### 3. Process of Preparation of the rCB

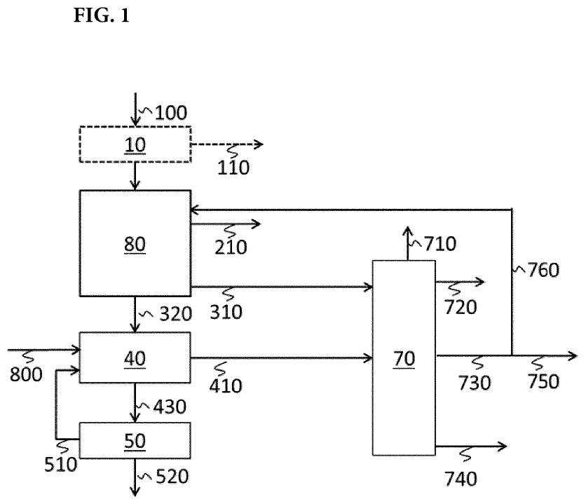

Another subject-matter of the present invention is the process of preparation of the rCB according to the invention starting from waste tyres. Said preparation process is a process for the conversion and more specifically a process for the solvolysis of waste tyres which comprises, with reference to FIG. 1, in combination with an embodiment according to the invention, at least the following stages:
a) a solid feedstock 100 based on waste tyres is sent into a reaction zone 80 in the presence of a liquid solvent 760 comprising aromatic compounds in order to at least partially dissolve said solid feedstock and to thermally decompose said at least partially dissolved solid feedstock at a temperature of less than 400° C., preferably of between 365° C. and 395° C. and more preferentially still of between 380° C. and 395° C. and at a pressure of less than 1.5 MPa, preferably of between 0.2 and 1.2 MPa, in order to obtain at least a gaseous effluent 310 and a first liquid effluent 320 comprising the rCB according to the invention, the ratio by weight of the liquid solvent 760 to the solid feedstock 100 being greater than 3 weight/weight;
b) the liquid effluent 320 obtained in stage a) is sent into a zone for filtration and washing 40 in the presence of a washing solvent in order to obtain a cake of filtered and washed rCB according to the invention 430 and a second liquid effluent 410, said stage b) being carried out at a temperature of between 55° C. and 95° C., preferably between 60° C. and 90° C. and more preferentially still between 65° C. and 85° C.;
c) said gaseous effluent 310 obtained on conclusion of stage a) is sent, at least in part, preferably in its entirety, and the second liquid effluent 410 obtained on conclusion of stage b) is sent, at least in part, preferably in its entirety, to a fractionation zone 70 in order to obtain at least a hydrocarbon cut 730 comprising a content of aromatic compounds of greater than 30% by weight with respect to the total weight of said hydrocarbon cut, preferably of greater than 40% by weight, and comprising:
   a content of C5-C10 hydrocarbon compounds of less than 20% by weight with respect to the total weight of the hydrocarbon cut 730, preferably of less than 10% by weight, more preferentially of between 1% and 8% by weight; and
   a content of C40+ hydrocarbon compounds of less than 5% by weight with respect to the total weight of said hydrocarbon cut 730, preferably of less than 3% by weight, more preferentially of less than 1% by weight and more preferentially still of less than 0.5% by weight;
d) said hydrocarbon cut 730 obtained on conclusion of stage c) is sent, at least in part, into the reaction zone 80 as liquid solvent 760 of stage a);
e) the cake of filtered and washed rCB according to the invention 430 obtained on conclusion of stage b) is dried in a drying zone 50 at a temperature of between 50° C. and 200° C., preferably for a period of time sufficient for the content of washing solvent in the dried cake to be less than 0.5% by weight with respect to the total weight of said dried cake.

Advantageously, the drying time is between 10 minutes and 36 hours, more preferentially between 1 hour and 15 hours, in order to recover the rCB according to the invention 520. According to an essential aspect of the process according to the invention, the use of such a recycled hydrocarbon cut as liquid solvent 760 of the reaction zone 80 (i.e. stage d) of the process according to the invention), with a rich content of aromatic compounds, a low content of C40+ compounds (vacuum residues) and a content of C5-C10 hydrocarbon compounds (petrol) which is not too high, and while using a solvent/solid feedstock ratio by weight of greater than or equal to 3 weight/weight, preferably of between 3 and 10 weight/weight, more preferentially between 4 and 7 weight/weight, makes possible a better dissolution and decomposition of the solid feedstock 100, thus maximizing the production of rCB while limiting the presence of carbon-based residues in said rCB.

The solid feedstock 100 used in the context of the present invention is advantageously based on tyres resulting from the treatment of waste tyres which can originate from any source, such as light vehicles (LV) or heavy goods vehicles (HGV), for example. Said solid feedstock can advantageously be provided in the form of tyre granules, i.e. in the form of particles with sizes of less than 6 mm. Preferably, said solid feedstock 100 is substantially devoid of textile fibres and metal wires, and/or of ground tyre material, i.e. lumps of ground tyres, with a characteristic size generally of between 1 cm and 20 cm. Thus, according to a preferential embodiment according to the invention, the solid feedstock 100 is sent into a pretreatment unit 10 in order to remove textile fibres and metal wires 110 from the solid feedstock 100. Such a pretreatment unit is well known to a person skilled in the art and can consist of grinders of various types (i.e. a rotary shear, a shredder, a granulator, a rechipper), a magnetic separator, or also a vibrating screen, a separation table.

According to stage a) of the conversion process, the rubber which is contained in the solid feedstock 100 is dissolved on contact with the liquid solvent 760 and is then thermally decomposed. The source and the composition of the liquid solvent 760 will be described in detail below. Stage a) is preferably carried out at a temperature of less than 400° C., preferably of between 365° C. and 395° C. and more preferentially still of between 380° C. and 395° C., and at a pressure of less than 1.5 MPa, preferably of between 0.2 and 1.2 MPa. On conclusion of stage a), the at least a gaseous effluent 310 and the first liquid effluent 320 comprising the rCB according to the invention, and optionally solid matter 210 contained in the waste tyres, such as metal wires or textile fibres, which are released and separated from the liquid effluent 320 obtained on conclusion of this stage, are obtained.

The first liquid effluent 320 comprising the rCB according to the invention is then sent into the filtration and washing zone 40 (i.e. stage b) of the preparation process according to the invention) in order to recover the cake of filtered and washed rCB according to the invention 430 and the second liquid effluent 410. This stage is carried out at a temperature of between 55° C. and 95° C., preferably between 60° C. and 90° C. and more preferentially still between 65° C. and 85° C. In an embodiment according to the invention, the viscosity of the second liquid effluent 410, measured at 100° C., is less than 10 cP, preferentially less than 5 cP, more preferentially less than 3 cP, as measured according to Standard ASTM D3236.

The filtration and washing unit can comprise any device making possible the filtration of the particles of rCB according to the invention contained in the first liquid effluent 320. Such a device can, for example, be provided in the form of a rotary filter preferentially operating at a temperature of between 55° C. and 95° C., preferably between 60° C. and 90° C. and more preferentially still between 65° C. and 85° C. During stage b), the cake of rCB according to the invention is washed using a washing solvent.

In an embodiment according to the invention, the washing solvent used during stage b) is a solvent external to the process 800, such as represented in FIG. 1. The solvent can be chosen from toluene or xylene, preferably xylene.

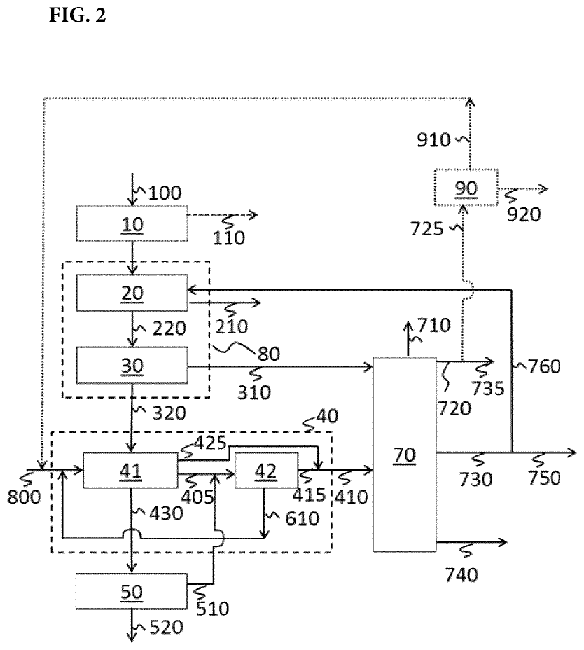

In another embodiment according to the invention, the washing solvent used during stage b) is composed, at least in part, of a light cut 720 obtained on conclusion of stage c). More particularly, with reference to FIG. 2, a fraction of the light cut 720 can be sent to a distillation column 90 via the line 725. The complementary fraction 735 of the light cut is sent out of the process according to the invention as upgradable product. At the outlet of the distillation column 90, a light cut 910 comprising aromatic compounds, the final boiling point of which is less than or equal to 200° C., preferably less than 150° C., is obtained which can be used, at least in part, as washing solvent of the filtration/washing zone 40. The heavier cut 920 can be sent out of the process as upgradable product 920.

The cake of filtered and washed rCB according to the invention 430 is sent into a drying unit 50 operating at a temperature of between 5° and 200° C., preferably between 5° and 150° C., in order to recover the rCB according to the invention 520 (i.e. stage e) of the process according to the invention). Advantageously, the vapour effluent 510 resulting from the drying unit 50 comprising the washing solvent is recycled in the washing/filtration unit 40.

According to the invention, the gaseous effluent 310 obtained on conclusion of stage a) and the second liquid effluent 410 obtained on conclusion of stage b) are sent into the fractionation unit 70 (i.e. stage c) of the process according to the invention) in order to produce at least a hydrocarbon cut 730 comprising a content of aromatic compounds of greater than 30% by weight with respect to the total weight of said hydrocarbon cut 730, and additionally comprising at least:
a content of C5-C10 hydrocarbon compounds of less than 20% by weight with respect to the total weight of the hydrocarbon cut 730, preferably of less than 10% by weight, more preferentially of between 1% and 8% by weight; and
a content of C40+ hydrocarbon compounds of less than 5% by weight with respect to the total weight of said hydrocarbon cut 730, preferably of less than 3% by weight, more preferentially of less than 1% by weight and more preferentially still of less than 0.5% by weight.

Advantageously, the hydrocarbon cut 730 also comprises a content of C10-C20 hydrocarbon compounds of between 20% and 65% by weight with respect to the total weight of the hydrocarbon cut, preferably of between 30% and 65% by weight and more preferentially still of between 45% and 65% by weight.

Advantageously, the hydrocarbon cut 730 also comprises a content of C20-C40 hydrocarbon compounds of between 30% and 80% by weight with respect to the total weight of the hydrocarbon cut, preferably of between 30% and 70% by weight and more preferentially still of between 30% and 55% by weight.

Advantageously, the hydrocarbon cut 730 has a starting boiling point of between 50° C. and 325° C., preferably of between 50° C. and 250° C., and a final boiling point of between 350° C. and 520° C., preferably of between 350° C. and 450° C.

Advantageously, the fractionation zone 70 also makes it possible to obtain non-condensable gases 710, the light cut 720, the final boiling point of which is preferentially between 250° C. and 325° C., and a heavy cut 740, the starting boiling point of which is preferentially between 350° C. and 450° C.

Advantageously, the light cut 720 can be sent, at least in part, as washing solvent into the washing and filtration zone 40 in order to obtain the cake of filtered and washed rCB according to the invention 430.

Advantageously, the light cut 720 comprises a content of C10-hydrocarbon compounds of greater than 60% by weight with respect to the total weight of the light cut 720.

Advantageously, the heavy cut 740 comprises a content of C40+ hydrocarbon compounds of greater than 60% by weight with respect to the total weight of the heavy cut 740.

According to the invention, a fraction of the hydrocarbon cut 730 is sent, at least in part, to the reaction zone 80 of stage a) as liquid solvent 760, the other part 750 advantageously being sent out of the process according to the invention as upgradable product. The ratio by weight of the liquid solvent 760 to the flow of the solid feedstock 100 injected into the reaction zone 80 is greater than or equal to 3 weight/weight (w/w), preferentially between 3 and 10 weight/weight, more preferentially between 4 and 7 weight/weight. Specifically, one of the characteristics of the liquid solvent 760 is that it contains a content of aromatics of greater than 30% by weight with respect to the total weight of said liquid solvent 760, making it possible to efficiently dissolve the solid feedstock 100 and to efficiently reduce the viscosity of the reaction medium in the reaction zone 80. Another advantage of the process according to the invention is that the use of such a solvent makes it possible to remain in liquid form while limiting the pressure in the reactors to a level of less than 1.5 MPa given the limited production of gases and light hydrocarbons in the reaction zone 80 and of the low content of C10-hydrocarbon compounds in the hydrocarbon cut 730.

So as to better understand the invention, the description given below (as applicational example) relates to a process for the conversion of waste tyres which makes it possible to maximize the production of rCB while limiting the presence of carbon-based residues in said rCB. With reference to FIG. 2, the solid feedstock 100 is sent into the pretreatment unit 10 in order to remove textile fibres and metal wires 110 from the solid feedstock 100. The solid feedstock, substantially devoid of textile fibres and metal wires, is subsequently sent into the reaction zone 80 making possible the thermal degradation of the waste tyres comprising a first stirred reactor 20 fed with liquid solvent 760 and targeted at promoting the dissolution of the tyre granules or ground tyre material contained in the solid feedstock 100. The liquid solvent/solid feedstock ratio by weight is greater than or equal to 3 weight/weight, preferably between 3 and 10, more preferentially between 4 and 7 weight/weight. The temperature in the reactor 20 is preferentially between 200° C. and 300° C., preferentially between 250° C. and 290° C. In the first stirred reactor 20, the ground material or granules are dissolved. The time required to carry out this dissolution is preferentially between 30 minutes and 2 hours. The lumps of rubbers, and the future rCB according to the invention which is gradually released from the rubber, remain in suspension by virtue of mechanical or hydrodynamic stirring, induced, for example, by an upward liquid stream resulting from recirculation by forced convection, or by any other means making it possible to keep the medium stirred. The metal wires, which are possibly still present in the solid feedstock and which would not have been dissolved, settle out and exit from the first stirred reactor 20 at its base via the line 210. Under these conditions, the temperature is too low for the carbon-carbon cracking reactions to start significantly and only the crosslinking bonds between polymers, such as the S—S bonds related to the vulcanization of the rubbers, can crack substantially. The liquid fraction 220 obtained containing the residual solid matter in suspension is directed to a second stirred reactor 30 in which the thermal degradation reactions are carried out under moderate temperature conditions, i.e. at a temperature of less than or equal to 400° C., preferably of between 365° C. and 395° C. and more preferentially still of between 380° C. and 395° C., and for a limited time (corresponding to the residence time of the liquid fraction in the reactor 30) preferentially of between 30 minutes and 2 hours, preferentially between 45 minutes and 90 minutes. The amount of heat required to carry out the thermal degradation reactions can be provided by an exchanger located on a pump-around (not represented in the figures) around the second stirred reactor 30, or by any other means, such as an exchanger at the wall of the reactor or an exchanger or an oven on the feedstock upstream of the reactor, for example. Stirring in the second stirred reactor 30 is maintained by virtue of a mechanical stirring system or by the pump-around system or by any other means known to a person skilled in the art. Preferentially, the pressure of the reactor is maintained at a level of less than 1.5 MPa by virtue of a control valve (not represented in the figures).

At the end of the reaction in the second stirred reactor 30, the first liquid effluent 320, containing the particles of rCB according to the invention in suspension, and the gaseous effluent 310 are obtained. The first liquid effluent 320 is subsequently sent into the filtration and washing zone 40, comprising a rotary filter 41 and an intermediate fractionation unit 42 (cf. FIG. 2). The rotary filter 41 preferentially operates at a temperature of between 50° C. and 200° C., and makes it possible to obtain a cake of rCB according to the invention and a liquid fraction 425. Said cake is subsequently washed by the washing solvent 800, such as toluene or xylene, preferably xylene, at a temperature of between 55° C. and 95° C., preferably between 60° C. and 90° C. and more preferentially still between 65° C. and 85° C., making it possible to recover the filtered and washed rCB according to the invention 430. After the filtration/washing stage, a washing stream 405 can be sent into the intermediate fractionation unit 42 in order to obtain a cut 610, which can be at least partially recycled upstream of the rotary filter 41 by means of the line as supplementary washing solvent, and a cut 415 which can be sent with the liquid fraction 425 into the fractionation zone 70 as second liquid effluent 410. The filtered and washed rCB according to the invention 430 is subsequently sent into the drying unit 50 operating at a temperature of between 50° C. and 200° C., advantageously for a period of time sufficient for the content of washing solvent in the dried cake to be less than 0.5% by weight with respect to the total weight of said dried cake. The filtered, washed and dried rCB according to the invention 520 can subsequently advantageously be pelletized (granulated) with water to form pellets of a few millimetres, for example in order to facilitate its transportation and its upgrading. The rCB thus produced can again be used in the elastomer industry as reinforcing agent, or as pigment for other applications in inks, plastics or paints, for example, after stages of subsequent treatment and of packaging of the substance depending on the uses and applications. The residual washing solvent can be recovered at the outlet of the drying unit 50 and be at least partially recovered via the line 510.

The gaseous effluent 310 exiting from the reaction zone 80 via the second reactor 30 and the second liquid effluent 410 resulting from the washing/filtration zone 40 are subsequently directed to the fractionation zone 70. The fractionation zone 70 can be constituted of heat exchangers, of gas-liquid separator drums, of a distillation column containing a withdrawal at the top, a withdrawal at the bottom and a sidestream withdrawal, or of a sequence of several distillation columns, such as a sequence of a distillation column at atmospheric pressure operating with a withdrawal at the top and a withdrawal at the bottom, followed by a distillation column operating under a low vacuum. This fractionation zone 70 makes it possible in particular to produce the hydrocarbon cut 730 comprising a content of aromatic compounds of greater than 30% by weight with respect to the total weight of said hydrocarbon cut 730, preferentially of greater than 40% by weight, and additionally comprising:
a content of C5-C10 hydrocarbon compounds of less than 20% by weight with respect to the total weight of the hydrocarbon cut 730, preferably of less than 10% by weight, more preferentially of between 1% and 8% by weight; and
a content of C40+ hydrocarbon compounds of less than 5% by weight with respect to the total weight of said hydrocarbon cut 730, preferably of less than 3% by weight, more preferentially of less than 1% by weight and more preferentially still of less than 0.5% by weight;
   at least a portion of which can be recycled as a liquid solvent 760 in the reaction zone 80, it being possible for the other portion 750 to be upgraded as product. Preferably, the hydrocarbon cut is sent into the first reactor 20 of the reaction zone 80 as liquid solvent.

This fractionation zone 70 also makes it possible to obtain non-condensable gases 710, the light cut 720, the final boiling point of which is preferentially between 250° C. and 325° C., and the heavy cut 740, the starting boiling point of which is preferentially between 350° C. and 450° C. Advantageously, the light cut 720 can be sent, at least in part, as washing solvent into the washing and filtration device 41 of the washing and filtration zone 40 in order to obtain the cake of filtered and washed rCB according to the invention 430.

During the start-up of the facility, in the absence of production of a stabilized intermediate cut, i.e. the hydrocarbon cut 730, it is possible temporarily to use an imported solvent which will preferentially be constituted of a content of aromatic molecules of greater than 40% by weight with respect to the total weight of the cut. This cut can thus be constituted, for example, of conversion effluents from the process for the FCC (Fluid Catalytic Cracking) catalytic cracking of middle distillate (light cycle oil (LCO)) or of heavy distillate (heavy cycle oil (HCO)), for example.

### EXAMPLES

The following examples illustrate preferential embodiments of the process according to the present invention and the production of rCB without, however, limiting the scope thereof. The process used to illustrate the invention is in accordance with that described in FIG. 2.

### Example 1 (in Accordance with the Invention)

In a first example, in accordance with the invention, use is made of waste tyre granules (solid feedstock), which are produced by granulators using grinders, which originate from heavy goods vehicle tyres and the grains resulting from the grinding have a size in the vicinity of 2 millimetres. The tyre granules result from a pretreatment unit 10 and are devoid of textile and metal fibres. The granules are subsequently sent continuously into a dissolution reactor where they are mixed with the liquid solvent resulting from the recycling of the hydrocarbon cut 730 from the fractionation zone 70. A portion of the hydrocarbon cut 730 is used as liquid solvent 760, the composition of which appears in Table 1 below. The amount of solid feedstock treated is 100 kg/h. The amount of solvent which is recycled in the reactor 20 is 500 kg/h, corresponding to a solvent/granules ratio by weight equal to 5 w/w. In the reactor 20, the temperature is kept equal to 290° C., which makes it possible to dissolve the granules. The liquid fractions and the future rCB in suspension are subsequently directed to the reactor 30, where the temperature is kept equal to 385° C. for one hour. At the outlet of the reactor 30, a first liquid effluent 320 and a gaseous effluent 310 are recovered, the latter being sent in its entirety into the fractionation zone 70. The first liquid effluent 320 is sent into a rotary filter 41 operating at 80° C. Washing of the filtered rCB is carried out with xylene at a temperature of 80° C. The second liquid effluent 410 collected at the outlet of the washing and filtration zone 40 is sent in its entirety to the fractionation zone 70. The filtered and washed rCB 430 is sent into a drying unit 50 operating at 150° C. for 24 hours, making it possible to recover the filtered, washed and dried rCB 520.

### Example 2 (not in Accordance with the Invention)

In Example 2, not in accordance with the invention, the stages of the conversion process and the operating conditions are identical to those of Example 1, except as regards the content of C40+ hydrocarbon compounds (vacuum residues or VRs) of the liquid solvent 760, which is outside the range according to the invention, and as regards the stage of washing the recovered carbon black (rCB), which is carried out at a temperature of 50° C.

The operating conditions of Examples 1 and 2 are summarized in Table 1 below.

TABLE 1

| | | Example | Example |
|---|---|---|---|
| | | 1 | 2 |
| Temperature of the reactor | ° C. | 385 | 385 |
| 30 | | | |
| Pressure of the reactor 30 | MPa | 0.9 | 0.9 |
| Flow rate of feedstock 100 | kg/h | 100 | 100 |
| Liquid solvent | w/w | 5 | 5 |
| 760/feedstock 100 | | | |
| Flow rate of recycle stream | kg/h | 500 | 500 |
| 760 | | | |
| Hydrocarbon cut 730 | | | |
| Gas | % by | 0.1 | 0.1 |
| | weight | | |
| Petrol (C5-205° C.) | % by | 6.6 | 5.3 |
| | weight | | |
| Gas oil (205-370° C.) | % by | 51 | 40.9 |
| | weight | | |
| VGO (370-520° C.) | % by | 41.9 | 33.6 |
| | weight | | |
| VR (520° C.+) | % by | 0.4 | 20.0 |
| | weight | | |
| Gaseous effluent 310 | kg/h | 85 | 54 |
| Liquid effluent 320 | kg/h | 515 | 546 |
| Solids in liquid effluent 320 | % by | 7.3 | 6.9 |
| | weight | | |
| Washing temperature | ° C. | 80 | 50 |
| Viscosity of the second | cP | 6.2 | 28.8 |
| liquid effluent 410 at 50° C. | | | |
| Viscosity of the second | cP | 2.3 | 7.4 |
| liquid effluent 410 at 100° C. | | | |

The main characteristics of the rCB obtained according to Examples 1 and 2 are summarized in Tables 2 and 3 below.

TABLE 2

| | | | Content of carbon- |
|---|---|---|---|
| | Ash content | S_{BET} | based residues |
| rCB | (% by weight) | (m²/g) | (% of C₁ area) |
| Example 1 | 12.8 | 67 | 0.05 |
| (in accordance) | | | |
| Example 2 (not in | 12 | 60 | 2 |
| accordance) | | | |

TABLE 3

| | % by | % by | % by | % by | % by | % by | % by | % by | OAN × |
|---|---|---|---|---|---|---|---|---|---|
| | weight | weight | weight | weight | weight | weight | weight | weight | 10⁻⁵ |
| rCB | C | O | H | N | S | SiO₂ | ZnS | VOCs | m³/kg |
| Example 1 | 81.4 | 0.9 | 0.6 | 0.2 | 3.3 | 4.8 | 8 | 2.1 | 71 |
| (in accordance) | | | | | | | | | |

1. Recovered carbon black (rCB) comprising:
carbon black, inorganic ash, and carbon-based residues resulting from the decomposition of pneumatic rubbers and/or elastomer residues,
wherein the content of carbon-based residues, determined with respect to the percentage of area of the C₁ peak measured by X-ray photoelectron spectroscopy, is less than or equal to 1% of said area of the C₁ peak, said percentage of area of the C₁ peak being calculated with respect to the total area of the C₀ to C₅ peaks.

2. The recovered carbon black according to claim 1, wherein the recovered carbon black comprises between 50% and 98% by weight of elemental carbon with respect to the total weight of said recovered carbon black.

3. The recovered carbon black according to claim 1, characterized in that it comprises between 0.2% and 4% by weight of element oxygen with respect to the total weight of said recovered carbon black.

4. The recovered carbon black according to claim 1, wherein the recovered carbon black comprises between 0.2% and 3% by weight of elemental hydrogen with respect to the total weight of said recovered carbon black.

5. The recovered carbon black according to claim 1, wherein the recovered carbon black comprises between 0.05% and 1% by weight of elemental nitrogen with respect to the total weight of said recovered carbon black.

6. The recovered carbon black according to claim 1, wherein the recovered carbon black comprises between 0.5% and 6% by weight of elemental sulfur with respect to the total weight of said recovered carbon black.

7. The recovered carbon black according to claim 1, wherein the recovered carbon black comprises a content of extracted volatile organic compounds of between 0.2% and 20% by weight with respect to the total weight of said recovered carbon black.

8. The recovered carbon black according to claim 1, wherein the content of inorganic ash is between 4% and 50% by weight with respect to the total weight of said recovered carbon black.

9. The recovered carbon black according to claim 1, wherein the recovered carbon black has a specific surface of between 30 and 150 m²/g.

10. The recovered carbon black according to claim 1, wherein the structural index, determined by the OAN analytical method in accordance with Standard ASTM D2414, is between 55 and 110.10⁻⁵ m³/kg.

11. The recovered carbon black according to claim 1, wherein said content of carbon-based residues, calculated with respect to the % of area of the C₁ peak, measured by photoelectron spectroscopy, is between 0.001% and 0.05% of area of the C₁ peak, said percentage of area of the C₁ peak being calculated with respect to the total area of the C₀ to C₅ peaks.

12. A process for the conversion of waste tires in order to obtain recovered carbon black (rCB) according to claim 1, said process comprising at least the following stages:
a) a solid feedstock (100) based on waste tires is sent into a reaction zone (80) in the presence of a liquid solvent (760) comprising aromatic compounds in order to at least partially dissolve said solid feedstock and to thermally decompose said at least partially dissolved solid feedstock at a temperature of less than 400° C. and at a pressure of less than 1.5 MPa in order to obtain a gaseous effluent (310) and a first liquid effluent (320) comprising the carbon black, the ratio by weight of the liquid solvent (760) to the solid feedstock (100) being greater than 3 weight/weight;
b) the first liquid effluent (320) obtained in stage a) is sent into a zone for filtration and washing (40) in the presence of a washing solvent in order to obtain a cake of filtered and washed carbon black (430) and a second liquid effluent (410), said stage b) being carried out at a temperature of between 55° C. and 95° C.;
c) said gaseous effluent (310) obtained on conclusion of stage a) is sent, at least in part, and the second liquid effluent (410) obtained on conclusion of stage b) is sent, at least in part, to a fractionation zone (70) in order to obtain at least a hydrocarbon cut (730) comprising a content of aromatic compounds of greater than 30% by weight with respect to the total weight of said hydrocarbon cut, and additionally comprising:
a content of C5-C10 hydrocarbon compounds of less than 20% by weight with respect to the total weight of the hydrocarbon cut; and
a content of C40+ hydrocarbon compounds of less than 5% by weight with respect to the total weight of said hydrocarbon cut;
d) said hydrocarbon cut (730) obtained on conclusion of stage c) is sent, at least in part, into the reaction zone (80) as liquid solvent (760) of stage a);
e) the cake of filtered and washed carbon black (430) obtained on conclusion of stage b) is dried at a temperature of between 50 and 200° C. in order to recover the carbon black.

13. The process according to claim 12, in which stage
a) comprises the following sub-stages:
a1) said solid feedstock (100) and said liquid solvent (760) are sent into a first stirred reactor (20) in order to at least partially dissolve said solid feedstock (100);
a2) said at least partially dissolved solid feedstock obtained on conclusion of stage a1) is sent into a second stirred reactor (30) in order to thermally decompose said solid feedstock at a temperature of less than or equal to 400° C. and to obtain a liquid effluent containing carbon black particles in suspension.

14. The process according to claim 12, wherein the content of aromatic compounds of the hydrocarbon cut (730) is greater than 40% by weight with respect to the total weight of said cut.

15. The process according to claim 12, wherein the content of C40+ hydrocarbon compounds in the hydrocarbon cut (730) is less than 3% by weight with respect to the total weight of said cut.
